(19) United States
(12) Patent Application Publication
(10) Pub. No.: US 2025/0190503 A1
(43) Pub. Date: Jun. 12, 2025

(54) Video Query Contextualization

(71) Applicant: Google LLC, Mountain View, CA (US)

(72) Inventors: Jessica Lee, Brooklyn, NY (US); Jamieson Robert Kerns, Santa Monica, CA (US); Nandhini Raman, Santa Clara, CA (US); Frederick Peter Brewin, Belvedere, CA (US); Dominique Alicia Brown, New York, NY (US); Sanjana Ponnada, Berkeley, CA (US); David Lee Sharon, Menlo Park, CA (US); Garima Chawla, Menlo Park, CA (US); Vivek Arvind Shah, Fremont, CA (US); Benji Bear, Mountain View, CA (US); Cory Keon Hee Lee, Millbrae, CA (US); Gagan Bansal, Sunnyvale, CA (US); Chenjie Gu, Sunnyvale, CA (US); Gang Wang, Mountain View, CA (US); Alex Gois, Mountain View, CA (US); Kevin Fongson, Mountain View, CA (US); Jennifer Blair, Summit, NJ (US)

(21) Appl. No.: 18/535,486

(22) Filed: Dec. 11, 2023

(51) Int. Cl. G06F 16/9535; G06F 40/40; G06T 11/60

(52) U.S. Cl. CPC G06F 16/9535; G06F 40/40; G06T 11/60

(57) ABSTRACT

Systems and methods for video query contextualization can include a router model that determines how to process and respond to the query associated with the video. The systems and methods can include obtaining an input query and video data, processing the input query and the video data with the router model to generate a video clip and routing data, and the routing data can then be utilized to determine which processing system to utilize to process the video clip and the input query. The video clip can then be processed with the determined processing system to generate a query response that may be provided to the user.

### FIELD

The present disclosure relates generally to processing queries associated with a video. More particularly, the present disclosure relates to video query contextualization that leverages a router model to facilitate the processing of video data associated with an obtained query.

### BACKGROUND

Understanding the world at large can be difficult. Whether an individual is trying to understand what the object in a displayed video is, trying to determine where else the object can be found, and/or trying to generate lists based on the contents of a video, text searching alone may not provide desired results. In particular, users may struggle to determine which words to use. Additionally, the words may not be descriptive enough and/or abundant enough to generate desired results.

A user may utilize screen capture to provide with a text query; however, the screen capture may be tedious and may require navigating away from playback of the video. Moreover, a single image alone may not capture the full sequence of interest.

### SUMMARY

Aspects and advantages of embodiments of the present disclosure will be set forth in part in the following description, or can be learned from the description, or can be learned through practice of the embodiments.

One example aspect of the present disclosure is directed to a computing system for processing a query associated with a video. The system can include one or more processors and one or more non-transitory computer-readable media that collectively store instructions that, when executed by the one or more processors, cause the computing system to perform operations. The operations can include obtaining an input query and video data. The input query can be associated with a video. The video data can be associated with the video. The operations can include processing the input query and the video data with a machine-learned router model to generate a video clip and routing data. The video clip can be generated based on the input query. The video clip can include a plurality of frames from the video. In some implementations, the routing data can include a determination of a particular processing system of a plurality of different processing systems to process the video clip with to determine a query response. The operations can include processing the video clip with the particular processing system of the plurality of different processing systems to determine one or more search results. The one or more search results can be associated with features in the video clip. The operations can include providing the one or more search results for display.

In some implementations, the video can be a displayed video that is currently provided for display. The one or more search results can be provided for display with the displayed video. In some implementations, the video clip can be generated based on the input query and a currently displayed frame of the displayed video. The video clip can include the currently displayed frame. The video clip and routing data can be generated without navigating away from a video playback of the displayed video. The one or more search results can be determined without navigating away from the video playback of the displayed video.

In some implementations, before obtaining the input query, the operations can include obtaining the video, processing the video with a transcription model to generate a transcript for the video, processing the video with one or more coarse classifiers to generate a plurality of entity tags associated with a plurality of objects detected in the video, and generating the video data based on the video, the transcript, and the plurality of entity tags.

In some implementations, the video data can include data associated with the plurality of frames of the video, one or more entity tags associated with features in the video, and metadata associated with the video. The one or more entity tags may have been generated and stored before the input query is obtained. In some implementations, the one or more entity tags can be generated by: processing the plurality of frames with one or more classification models to determine one or more classification labels based on detected features in the plurality of frames and generating entity tags for one or more respective frames of the plurality of frames. The one or more entity tags can be descriptive of the one or more classification labels associated with the one or more respective frames.

In some implementations, the machine-learned router model can be trained to segment data from video data based on the query and determine processing instructions. The machine-learned router model can include a generative language model trained to generate application programming interface calls. The particular processing system can include one or more embedding models, one or more search engines, and one or more databases.

Another example aspect of the present disclosure is directed to a computer-implemented method for processing a query associated with a video. The method can include obtaining, by a computing system including one or more processors, an input query and video data. The input query can be associated with a video. The video data can be associated with the video. The method can include processing, by the computing system, the input query and the video data with a machine-learned router model to generate a video clip and routing data. The video clip can be generated based on the input query. The video clip can include a plurality of frames from the video. In some implementations, the routing data can include a determination of a particular machine-learned model of a plurality of different models to process the video clip with to determine a query response. The method can include processing, by the computing system, the video clip with the particular machine-learned model of the plurality of different models to generate a model output. The model output can be associated with features in the video clip. The method can include processing, by the computing system, the model output with a generative model to generate the query response. The generative model can include a natural language processing model. The method can include providing, by the computing system, the query response for display. The query response can be provided for display with the video.

In some implementations, the particular machine-learned model can include a vision language model. The vision language model can be configured to process image data and generate text data descriptive of features of the image data. The method can include processing, by the computing system, the video clip with a segmentation model to generate a plurality of segmentation masks associated with a plurality of frames of the video clip. The plurality of segmentation masks can be descriptive of a silhouette of a particular object in the plurality of frames of the video clip. The method can include generating, by the computing system, an augmented video clip based on the video clip and the plurality of segmentation masks. The augmented video clip can include the video clip with one or more graphical indicators associated with the particular object. The method can include providing, by the computing system, the augmented video clip for display. In some implementations, the one or more graphical indicators can include highlighting the particular object within the augmented video clip. The one or more graphical indicators can include tinting portions of the plurality of frames of the video clip that are outside the silhouette of the particular object. In some implementations, the routing data can include one or more application programming interface calls associated with transmitting the video clip to the particular machine-learned model and obtaining model output.

Another example aspect of the present disclosure is directed to one or more non-transitory computer-readable media that collectively store instructions that, when executed by one or more computing devices, cause the one or more computing devices to perform operations. The operations can include obtaining an input query and video data. The input query can be associated with a displayed video. The video data can be associated with the displayed video. The operations can include processing the input query and the video data with a machine-learned router model to determine a subset of the video data and generate routing data. The subset of the video data can be determined based on the input query. In some implementations, the subset of the video data can include data associated with the displayed video. The routing data can include a determination of a particular machine-learned model of a plurality of different models to process the subset of the video data with to determine a query response. The operations can include processing the subset of the video data with the particular machine-learned model of the plurality of different models to generate a model output. The model output can be associated with features in the subset of the video data. The operations can include processing the input query and the model output with a generative model to generate the query response. The query response can include a natural language response that is responsive to the input query and can include details from the model output. The operations can include providing the query response for display. The query response can be provided for display with the displayed video.

In some implementations, the subset of the video data can include a subset of a plurality of entity tags associated with detected features in the displayed video. The plurality of different models can include a vision language model, an embedding model, and a plurality of classification models. The operations can include obtaining a progress bar selection and generating a video clip based on the progress bar selection. The model output can be generated by processing the video clip with the particular machine-learned model of the plurality of different models.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example video query contextualization system according to example embodiments of the present disclosure.

FIG. 2 depicts a block diagram of an example query processing system according to example embodiments of the present disclosure.

FIG. 3 depicts a flow chart diagram of an example method to perform video query processing according to example embodiments of the present disclosure.

FIG. 4A depicts an illustration of an example query input interface according to example embodiments of the present disclosure.

FIG. 4B depicts an illustration of an example query formulation interface according to example embodiments of the present disclosure.

FIG. 4C depicts an illustration of an example query response interface according to example embodiments of the present disclosure.

FIG. 5A depicts an illustration of an example generative response interface according to example embodiments of the present disclosure.

FIG. 5B depicts an illustration of an example follow-up response interface according to example embodiments of the present disclosure.

FIG. 5C depicts an illustration of an example customization interface according to example embodiments of the present disclosure.

FIG. 5D depicts an illustration of an example updated response interface according to example embodiments of the present disclosure.

FIG. 5E depicts an illustration of example result response types according to example embodiments of the present disclosure.

FIG. 5F depicts an illustration of example generative response types according to example embodiments of the present disclosure.

FIG. 5G depicts an illustration of an example itinerary response according to example embodiments of the present disclosure.

FIG. 5H depicts an illustration of an example recipe response according to example embodiments of the present disclosure.

FIG. 5I depicts an illustration of an example quantitative reasoning response according to example embodiments of the present disclosure.

FIG. 6A depicts an illustration of an example video query processing interface according to example embodiments of the present disclosure.

FIG. 6B depicts an illustration of an example frame processing interface according to example embodiments of the present disclosure.

FIG. 6C depicts an illustration of an example clip processing interface according to example embodiments of the present disclosure.

FIG. 6D depicts an illustration of an example manual selection interface according to example embodiments of the present disclosure.

FIG. 6E depicts an illustration of an example automated selection interface according to example embodiments of the present disclosure.

FIG. 6F depicts an illustration of example search selection interface elements according to example embodiments of the present disclosure.

FIG. 7 depicts a flow chart diagram of an example method to perform video clip generation and routing according to example embodiments of the present disclosure.

FIG. 8 depicts a flow chart diagram of an example method to perform video query contextualization and processing according to example embodiments of the present disclosure.

FIG. 9A depicts a block diagram of an example clip search interface according to example embodiments of the present disclosure.

FIG. 9B depicts a block diagram of an example song search interface according to example embodiments of the present disclosure.

FIG. 10A depicts a block diagram of an example computing system that performs video query contextualization according to example embodiments of the present disclosure.

FIG. 10B depicts a block diagram of an example computing system that performs video query contextualization according to example embodiments of the present disclosure.

Reference numerals that are repeated across plural figures are intended to identify the same features in various implementations.

### DETAILED DESCRIPTION

Generally, the present disclosure is directed to systems and methods for video query contextualization. In particular, the systems and methods disclosed herein can leverage a router model and/or an input interface to segment and process relevant portions of video data associated with an input query. For example, an input query may be obtained during the playback of a displayed video. The input query and/or video data associated with the displayed video can be processed with the router model to determine a subset of the video data to process and generate routing data. The routing data can be descriptive of instructions for a particular processing system (e.g., a particular machine-learned model) to process the subset of the video data with to generate a query response. The particular processing system can process the subset of the video data and/or the input query based on the routing data to generate a query response. The query response can include search results and/or a model-generated response that may be responsive to the input query. For example, the input query may include a question about the content provided for display in the displayed video, and the query response may be a natural language answer to the question and may be provided with one or more relevant search results.

The input query can be received via an input interface, which may include an input query box that can be utilized to obtain an input query during the playback of a video. In some implementations, the input interface can include options for selecting portions of the video to segment for search. The input query can include a request for additional information associated with content associated with a displayed video. Alternatively and/or additionally, the input query may be obtained along with a video file in which the query includes a first data format (e.g., the input query) and a second data format (e.g., the video file including the video data). The video data may be provided by the user, obtained from one or more databases (e.g., a web database, a local database, and/or other databases). In some implementations, the video data can be associated with an uploaded video, a linked video, and/or other video in place of or in combination with a displayed video.

The router model can process the input query and/or the video data to determine a subset of the video data to segment and process. Additionally and/or alternatively, the router model can process the input query and/or the video data to generate routing data descriptive of a particular processing system of a plurality of different processing systems to process the video data with to respond to the query. The subset of video data may be processed to generate a video clip that can then be processed with a particular processing system based on the routing data. The particular processing system can be determined based on the type of data requested by the input query. For example, a vision language model and/or a classification model may be utilized if the input query is asking what is being displayed, while an embedding model and/or a search engine may be utilized if the input query is requesting product links and/or related items. The particular processing system may generate a model output that may include search results, generative model outputs, classification model outputs, segmentation masks, and/or other outputs. In some implementations, the systems and methods may include a generative model that processes the model output and/or the input query to generate a query response that may be structured to be responsive to the input query while including details from the model output.

The query response can be provided for display with the displayed video such that a user can request information associated with a displayed video without navigating away from the video. A user may input follow-up queries and/or prompts that can be processed in isolation and/or may be conditioned based on the previous input query, the previous subset of the video data, and/or the previous query response. Customization options may be provided by the input interface to adjust and/or augment the portion of the video data that is processed.

Video query contextualization can be leveraged to perform searches based on both an input query and a video that may be provided for display and/or input as part of the query. In particular, a user may be watching a video in a browser and/or in a video player application and may have a question associated with the displayed content. A video query contextualization system can be leveraged to determine what portion of the video data to process and with what models to process the video data with to determine a query response. For example, the input query may be requesting additional information associated with a particular object in the displayed video. The video query contextualization system can process the input query to determine that object detection, classification, and search is to be performed, then detect the object, segment the relevant portion of the video to generate a video clip that can then be processed to perform the search and/or the classification. In some implementations, entity tags and/or other metadata may be processed to aid in video clip generation and/or to generate the query response.

When watching a video, a user may have a question about the content provided for display (e.g., depicted objects and/or depicted locations (e.g., “when was this object created?”, “what is this object?”, “where is this?”, “provide me with a product link”, and/or “cost of this shirt”)); however, a user may not currently have enough information to craft a query that accurately details their question, which may lead to irrelevant search results and/or irrelevant query responses. Alternatively and/or additionally, processing a screenshot of the video with the query may provide a more detailed query; however, generating and providing the screenshot to a search engine may be tedious and a single frame may not provide enough detail. For example, the input query may request information about a sequence of frames (e.g., a sequence of movements associated with a basketball move, a dance move, an act, etc.). Additionally, processing an entire video with a plurality of different processing pipelines can be computationally expensive.

The video query contextualization system can include a router model (e.g., a router LLM) that can be leveraged to determine an intent of the query, which can then be leveraged to determine what processing techniques to utilize to respond to the query. For example, the router model can include a router LLM that is configured and/or trained to understand a query intent and generate one or more application programming interface (API) calls to instruct the system how to process the video data to determine a query response. In particular, the router model can be leveraged to determine what portion of the video data (e.g., which set of frames, which region of the video, the audio, the entity tags, the transcript, and/or other data) to process and with which models (e.g., a vision language model, a search engine, and/or other models) to process the subset of the video data with to determine a response to the query. The router model can reduce the amount of data processed and may reduce the number of processing pipelines utilized during each search instance, which can reduce the computational cost of performing the search, while leveraging relevant information from the video for the search.

The video query contextualization system can process multimodal data including video and text to provide more relevant search results to the user without the high computational cost of processing an entire video. Users can utilize the video query contextualization system to obtain additional information about content depicted in a video without having to navigate away from the video playback.

The systems and methods of the present disclosure provide a number of technical effects and benefits. As one example, the system and methods can provide a video query interface for receiving and processing queries associated with a video. In particular, the systems and methods disclosed herein can leverage a router model and a plurality of video data processing systems to perform input query and video data processing. The router model can process the input query to determine a subset of the video data to process and to determine a particular processing system of the plurality of video data processing systems to process the subset of the video data. The router model can be utilized to reduce the computational cost of video data processing by (1) reducing the size of data processed and (2) reducing the processing techniques utilized during each search instance.

Another technical benefit of the systems and methods of the present disclosure is the ability to leverage preprocessing information for responding to the input query. For example, the systems and methods can include one or more preprocessing tasks to generate a transcript, annotation, high-level (and/or coarse) classifications, entity tags, and/or other data that can be stored with the video to be utilized as part of the video data. The systems and methods disclosed herein may identify portions of the preprocessing output data as being relevant to responding to the query. The data can then be segmented from the video data and processed with one or more query processing systems. In some implementations, one or more video clips may be generated for processing based on the preprocessing output data. The preprocessing output data can be utilized for a plurality of different search instances by a plurality of different users. Therefore, the preprocessing tasks may reduce the aggregate computational cost of query processing by leveraging the preprocessing output data for a plurality of different search instances and/or a plurality of different users without relying on iteratively performing the preprocessing task as the data is stored and accessible for multiple uses.

Another example of technical effect and benefit relates to improved computational efficiency and improvements in the functioning of a computing system. For example, the systems and methods disclosed herein can leverage the router model and the preprocessing output data to provide a more comprehensive multimodal search query that can mitigate the use of additional searches and additional search result page browsing, which can save time and computational power. Additionally and/or alternatively, the systems and methods can provide valuable query context while reducing the computational cost of processing a full video and while reducing the cost of performing a plurality of different processing techniques that may or may not be useful to responding to the query. In particular, the systems and methods disclosed herein can provide more contextually aware search results while saving on computational resources that would be required for video processing by limiting what is processed and reducing the number of processing techniques performed.

With reference now to the Figures, example embodiments of the present disclosure will be discussed in further detail.

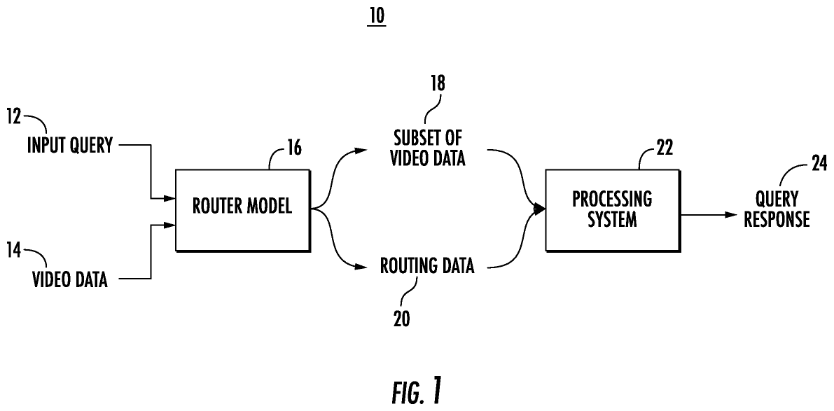

FIG. 1 depicts a block diagram of an example video query contextualization system 10 according to example embodiments of the present disclosure. In some implementations, the video query contextualization system 10 is configured to receive, and/or obtain, a set of input data including an input query 12 descriptive of a request for additional information associated with the displayed content and, as a result of receipt of the input data, generate, determine, and/or provide output data including a query response 24 that is descriptive of a response to the request for additional information. Thus, in some implementations, the video query contextualization system 10 can include a router model 16 that is operable to determine which data to process and how to process that data.

The video query contextualization system 10 can be utilized to obtain and respond to input queries 12 associated with a video (e.g., associated with a displayed video). In particular, the video query contextualization system 10 can process an input query, determine an intent of the input query 12, determine a relevant portion of the video data 14 based on the determined intent, determine a relevant processing system pipeline based on the determined intent, and then process the relevant portion with the relevant processing system pipeline to generate a model output that can be utilized to generate the query response 24.

For example, the video query contextualization system 10 can obtain an input query 12. The input query 12 can be associated with a displayed video and may be descriptive of a request for additional information about content from the displayed video. The video query contextualization system 10 can obtain video data 14 based on the input query 12 and/or based on the displayed video being provided for display. The video data 14 can include the displayed video, entity tags for content displayed in the video, data descriptive of a video title and video descriptive, video metadata, data descriptive of chapter titles, and/or other data associated with the displayed video.

The router model 16 can process the input query 12 to determine an intent of the input query 12. Based on the determined intent, the router model 16 can determine a subset of the video data 18 to transmit for processing and can generate routing data 20 descriptive of a particular processing system 22 to process the subset of video data with to generate the query response 24. The intent can be associated with a particular type of data requested (e.g., classification data request, search result request, graphical representation request, content generation request, etc.). In some implementations, the intent can be associated with a level of granularity requested, content (e.g., an object, a sequence, a location, etc.) associated with the information request, and/or other information. The subset of video data 18 may include a time frame of the video to clip and process, metadata to process, entity tags to process, transcript portions to process, and/or other video data 14 portions. The routing data 20 can include instructions for transmitting the subset of the video data 18 to the particular processing system 22 to process the subset of the video data 18 to generate the query response 24. In some implementations, the routing data 20 can include application programming interface calls for transmitting and processing the video data 14.

The video query contextualization system 10 can transmit the subset of the video data 18 to the particular processing system 22 based on the routing data 20. The particular processing system 22 can process the subset of the video data 18 to generate the query response 24. The particular processing system 22 can include an embedding model, a search engine, a classification model, a vision language model, a large language model, an image generation model, a list generation model, an augmentation model, a segmentation model, a sentiment analysis model, a semantic understanding model, a summarization model, and/or other processing models. The query response 24 can include data responsive to the information request of the input query 12. In some implementations, the query response 24 can include text data, image data, audio data, latent encoding data, graph representation data, tabular data, multimodal data, and/or other data.

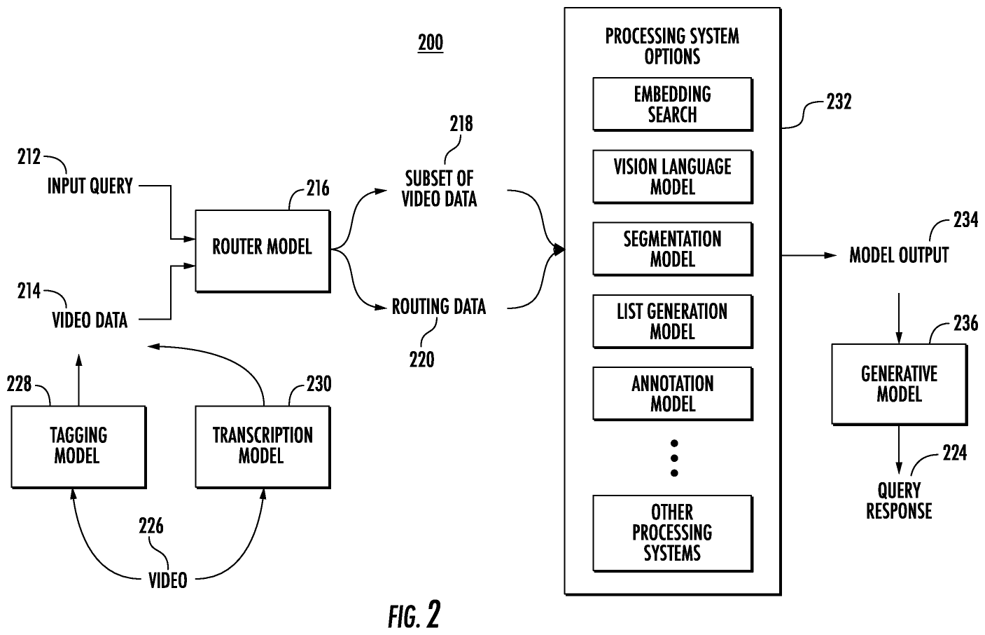

FIG. 2 depicts a block diagram of an example query processing system 200 according to example embodiments of the present disclosure. The query processing system 200 is similar to video query contextualization system 10 of FIG. 1 except that query processing system 200 further includes model output post processing.

For example, the query processing system 200 can obtain an input query 212. The input query 212 can be associated with a displayed video 226 and may be descriptive of a request for additional information about content from the displayed video 226. For example, the input query 212 may include a text string descriptive of a question about an object, person, place, and/or sequence depicted by the displayed video 226. The query processing system 200 can obtain video data 214 based on the input query 212 and/or based on the displayed video 226 being provided for display. The video data 214 can include the displayed video 226, entity tags for content displayed in the video, data descriptive of a video title and video descriptive, video metadata, data descriptive of chapter titles, and/or other data associated with the displayed video 226.

In some implementations, the displayed video 226 can be preprocessed to generate the video data 214. In particular, the displayed video 226 may have been preprocessed with a tagging model 228 to generate a plurality of entity tags associated with a plurality of high-level entity classifications (e.g., object classifications, location classifications, manufacturer tagging, etc.). The entity tags may include a label associated with the classification and may be tagged to the frames associated with the detected object, location, manufacturer, sequence, etc. Additionally and/or alternatively, a transcription model 230 can process the video 226 to generate a transcription descriptive of the audio of the displayed video 226. In some implementations, other preprocessing techniques may be utilized to determine and/or generate chapters, annotations, chapter titles, etc. The entity tags, the transcription, and/or the other preprocessing data may be stored with the displayed video 226 as part of the video data 214. In some implementations, the displayed video 226 may be stored in a video database with a plurality of other videos. The video database may determine which videos get preprocessed and/or the extent of the preprocessing. For example, all videos may be processed with the transcription model to generate transcripts for the videos; however, only a subset of the plurality of videos may be preprocessed for entity tagging and/or chapter generation. The determination of which videos to preprocess may be based on trends, the poster, the initial viewing traffic, the topic, and/or other contexts.

The router model 216 can process the input query 212 to determine an intent of the input query 212. Based on the determined intent, the router model 216 can determine a subset of the video data 218 to transmit for processing and can generate routing data 20 descriptive of a particular processing system from the plurality of processing system options 232 to process the subset of video data with to generate the query response 224. The intent can be associated with a particular type of data requested (e.g., classification data request, search result request, graphical representation request, content generation request, etc.). In some implementations, the intent can be associated with a level of granularity requested, content (e.g., an object, a sequence, a location, etc.) associated with the information request, and/or other information. The subset of video data 218 may include a time frame of the video to clip and process, metadata to process, entity tags to process, transcript portions to process, and/or other video data 214 portions. The routing data 220 can include instructions for transmitting the subset of the video data 218 to the particular processing system from the plurality of processing system options 232 to process the subset of the video data 218 to generate the query response 224. In some implementations, the routing data 220 can include application programming interface calls for transmitting and processing the video data 214.

The plurality of processing system options 232 can include a plurality of different processing systems, which can include a plurality of different models and/or a plurality of different model configurations. The plurality of processing system options 232 can include an embedding search processing system, a vision language model, a segmentation model, a list generation model, an annotation model, and/or other processing systems (e.g., other machine-learned models and/or processing engines). The embedding search processing system can include processing the video, a video clip, one or more frames, transcription, chapters, entity labels, context data, and/or the intent data with an embedding model to generate an embedding that can be utilized to determine other embeddings similar to the generated embedding, and then determining the search results associated with the other embeddings that are similar to the generated embedding. For example, a video clip may be generated based on the determined intent data. The video clip can be processed with an embedding model to generate a video embedding and/or a plurality of frame embeddings associated with the plurality of frames within the video clip. The video embedding and/or the plurality of frame embeddings can be utilized to query an embedding space to determine similar embeddings and/or other embeddings within one or more learned distributions. The embedding space querying can be utilized to determine search results, which may include videos, images, labels, web resources, and/or other data. The vision language model can include a generative model configured, trained, and/or tuned to process image data and/or text data to generate a natural language output that may be descriptive of an image caption for the image data and/or may include a response to a question of the text data in which the response is based on the semantic understanding of the image data. The segmentation model can segment video clips from the video, frames from the video, objects depicted within the video, and/or other portions of the video (e.g., a region that depicts a particular individual and/or location). The list generation model can include a generative model and/or one or more other models to semantically understand the video and/or a prompt and generate a list based on the semantic understanding. The annotation model can be trained, configured, and/or tuned to annotate at least a portion of the video based on the user input. The annotations may be based on outputs from a generative model, a classification model, a segmentation model, an augmentation model, a detection model, an OCR model, and/or other models.

Additionally and/or alternatively, a video clip may be generated based on the subset of video data 218 and/or the routing data 220. For example, the routing data can facilitate the processing of the subset of video data 218 to generate the video clip. The subset of video data can be processed to determine a begin frame and an end frame based on the input query 212 and/or the determined intent. The begin frame and end frame determination can then be utilized to generate a video clip by segmenting a portion of the video between the begin frame and end frame. In some implementations, the video clip may be generated based on a user selection of a particular frame and/or a user selection of a time frame of the video.

The query processing system 200 can transmit the subset of the video data 218 to the particular processing system from the plurality of processing system options 232 based on the routing data 220. The particular processing system from the plurality of processing system options 232 can process the subset of the video data 218 to generate a model output 234. The particular processing system from the plurality of processing system options 232 can include an embedding model, a search engine, a classification model, a vision language model, a large language model, an image generation model, a list generation model, an augmentation model, a segmentation model, a sentiment analysis model, a semantic understanding model, a summarization model, and/or other processing models. The model output 234 can include classification labels, summaries, annotations, search results, generated content, segmentation masks, captions, and/or other data.

A generative model 236 may process the model output 234 (and/or model outputs) to generate the query response 224. The generative model 234 can include a generative language model, a list generation model, a graph generation model, an image generation model, and/or other generative models. The query response 224 can include data responsive to the information request of the input query 212. In some implementations, the query response 224 can include text data, image data, audio data, latent encoding data, graph representation data, tabular data, multimodal data, and/or other data.

In some implementations, the query processing system 200 may utilize a plurality of different processing systems for the query response 224 generation. For example, a visual search may be performed with an embedding model and a search engine to determine an instance-level object recognition (e.g., a product name and/or person identification), and a vision language model may process the input query 212 and the subset of video data 218 to generate an image caption that can be utilized to perform a high-level verification of the object type. Alternatively and/or additionally, a classification model and/or other model may be utilized for identification and/or verification.

Additionally and/or alternatively, the router model 216 may include a lightweight generative language model, and the query processing system 200 may include one or more fulfillment LLMs (large language models) below the router model 216. The router model 216 can determine API calls, determine which data to obtain, what data to send, and/or when to send. The router model 216 may obtain and/or process additional context data to perform the query processing. For example the router model 216 may access and/or process a chat history, a viewing history, a search history, a purchase history, and/or general profile data for the processing determination.

In some implementations, the salient portions of the video may be determined with a saliency model that processes user-specific, group-specific, and/or global viewing data to determine portions and/or regions that are likely to be portions and/or regions of interest. The video clip generation may be based on a saliency model output.

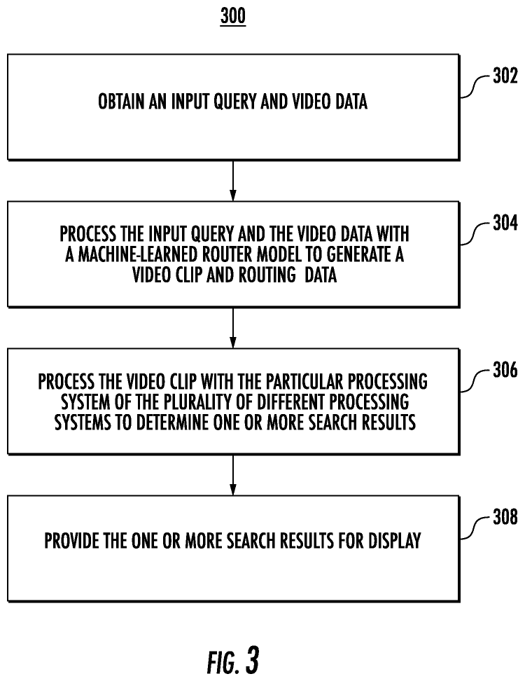

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain an input query and video data. The input query can be associated with a displayed video. Alternatively and/or additionally, the input query and/or the video data may be associated with a video file uploaded by the user and/or obtained from one or more databases. The input query can include text data, image data, audio data, latent encoding data, multimodal data, and/or other data. In some implementations, the input query may be obtained via an input query box, which may be associated with a browser application, a video player application, an overlay application, and/or another application. The video data can be associated with the displayed video. In some implementations, the video data can include data associated with the plurality of frames of the displayed video, one or more entity tags associated with features in the displayed video, and/or other metadata associated with the displayed video. The video data may include the title, the author, the categories, manual tags, automatically determined tags, and/or other data. The one or more entity tags may have been generated and stored before the input query is obtained.

In some implementations, the one or more entity tags can be generated by processing the plurality of frames with one or more classification models to determine one or more classification labels based on detected features in the plurality of frames and generating entity tags for one or more respective frames of the plurality of frames. The one or more entity tags can be descriptive of the one or more classification labels associated with the one or more respective frames. The entity tags may be associated with coarse classifications, fine-grained classifications, object type classifications, object-instance classifications, manufacturer label, product label, color label, topic label, and/or other labels.

At 304, the computing system can process the input query and the video data with a machine-learned router model to generate a video clip and routing data. The video clip can be generated based on the input query. In some implementations, the video clip can include a plurality of frames from the displayed video. The video clip may be generated based on the input query, the currently displayed frame, video metadata, object detection, pre-determined segments, model-determined segments, and/or other contexts. The routing data can include a determination of a particular processing system of a plurality of different processing systems to process the video clip with to determine a query response. The routing data may include one or more application programming interface calls. In some implementations, the video clip can be generated based on the input query and/or a currently displayed frame of the displayed video. The video clip can include the currently displayed frame. The machine-learned router model may have been trained to segment data from video data based on the query and determine processing instructions.

The machine-learned router model can include a generative language model trained to generate application programming interface calls. In some implementations, the router model may be communicatively connected with a plurality of different processing systems, which may be configured to receive data from the router model based on the routing data.

At 306, the computing system can process the video clip with the particular processing system of the plurality of different processing systems to determine one or more search results. The one or more search results can be associated with features in the video clip. In some implementations, the particular processing system can include one or more embedding models, one or more search engines, and/or one or more databases. For example, the particular processing system may be a search system. The search system may process the video clip and/or the input query to generate a query embedding. The query embedding can then be utilized to determine the one or more search results (e.g., via a nearest embedding neighbor determination). The one or more search results may be associated with other videos, images, and/or other web resources (e.g., articles, product listings, blogs, social media posts, etc.).

At 308, the computing system can provide the one or more search results for display. The one or more search results can be provided for display with the displayed video. The video clip and routing data can be generated without navigating away from a video playback of the displayed video. The one or more search results can be determined without navigating away from the video playback of the displayed video. The one or more search results, the input query, and the displayed video may be provided for display simultaneously. The displayed video may continue to play as the input query is obtained and processed.

In some implementations, before obtaining the input query, the computing system can obtain the displayed video, process the displayed video with a transcription model to generate a transcript for the displayed video, process the displayed video with one or more coarse classifiers to generate a plurality of entity tags associated with a plurality of objects detected in the displayed video, and generate the video data based on the displayed video, the transcript, and the plurality of entity tags.

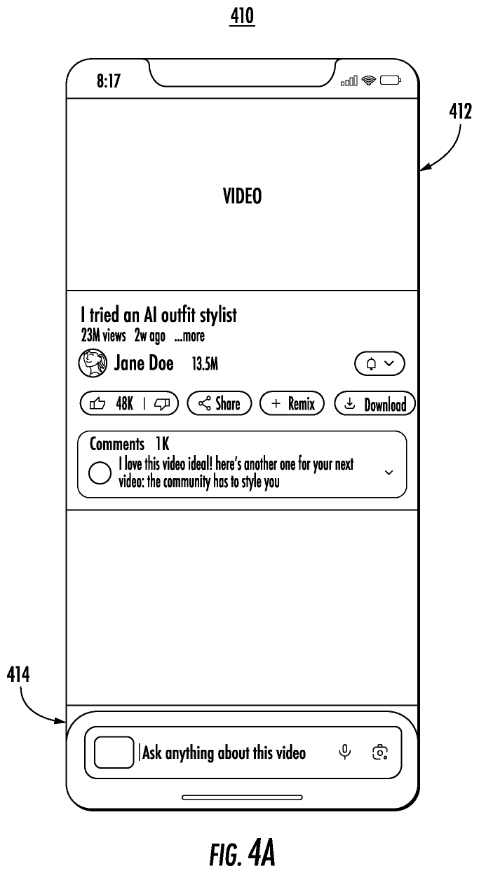

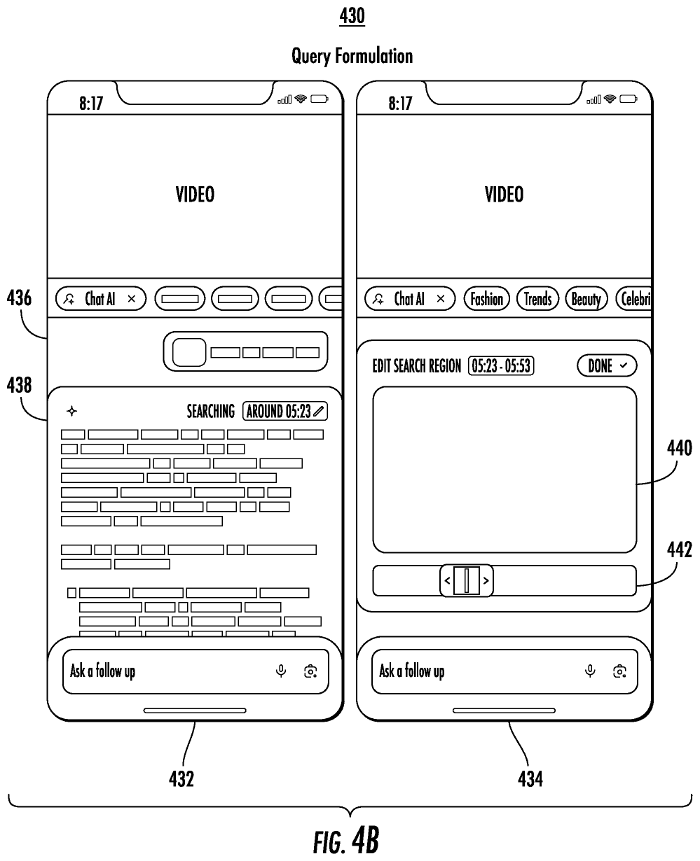

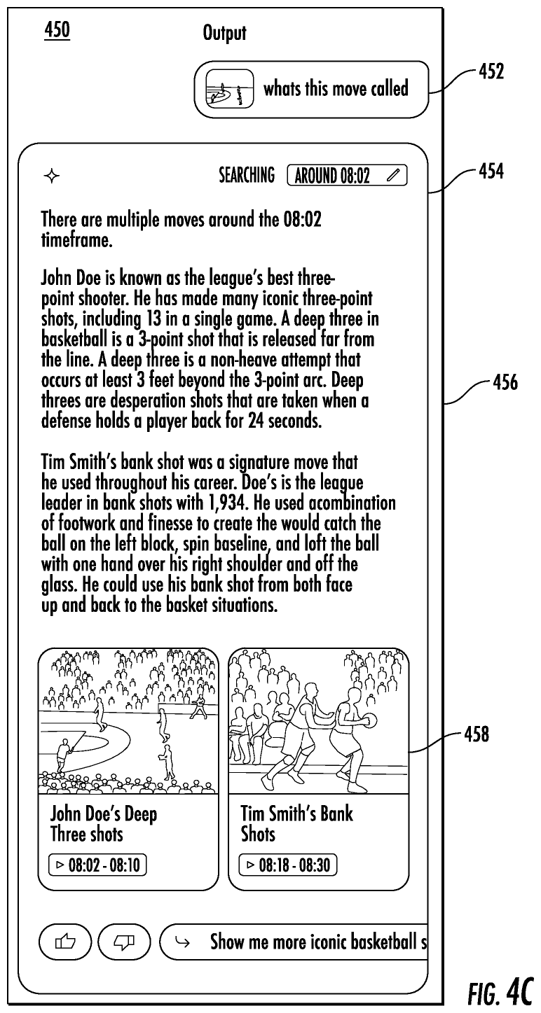

FIG. 4A depicts an illustration of an example query input interface 410 according to example embodiments of the present disclosure. In particular, FIG. 4A depicts an initial query input interface 410 configured to continue to display the displayed video 412 and to receive an input query via a query input box 414. The initial query input interface 410 can be provided in response to a user providing an input requesting a search interface. The initial query input interface 410 may be requested via a swipe gesture, an operating system input, and/or a selection of a user interface element within the browser and/or the video player application. The query input box 414 may include a thumbnail of the frame and/or frames displayed when the search interface was selected. Additionally and/or alternatively, the query input box 414 may be configured to receive text inputs, image inputs, audio inputs, and/or file inputs.

FIG. 4B depicts an illustration of an example query formulation interface 430 according to example embodiments of the present disclosure. In particular, FIG. 4B depicts a query formulation interface 430 that may be displayed after the input query 436 is obtained via the query input box 414. The query formulation interface 430 can include a buffering screen 432 that is displayed while the query is processed. The buffering screen 432 may continue to play the displayed video, may display the input query 436, and may include a response panel 438 that is where the query response will be displayed. In some implementations, the user may adjust the portion of the video that is processed with the query. The segment customization interface 434 can include a frame selection bar 442 and a display window 440. The frame selection bar 442 can depict a plurality of thumbnails associated with frames in the video and may be associated with a video progress bar. The frame selection bar 442 can include a selection interface element that can be utilized to select the portion of the video to segment and process. The display window can display one or more of the frames that were selected for processing.

FIG. 4C depicts an illustration of an example query response interface 450 according to example embodiments of the present disclosure. In particular, FIG. 4C depicts a query response interface 450 that includes the input query 452, a time indicator 454, a text response 456, and a search result response 458. The time indicator 454 can be descriptive of a portion of the video that was searched. The text response 456 can include a natural language response to the input query 452 and may be generated by summarizing one or more search results and/or may be generated by generating a response that includes one or more details obtained from one or more machine-learned models.

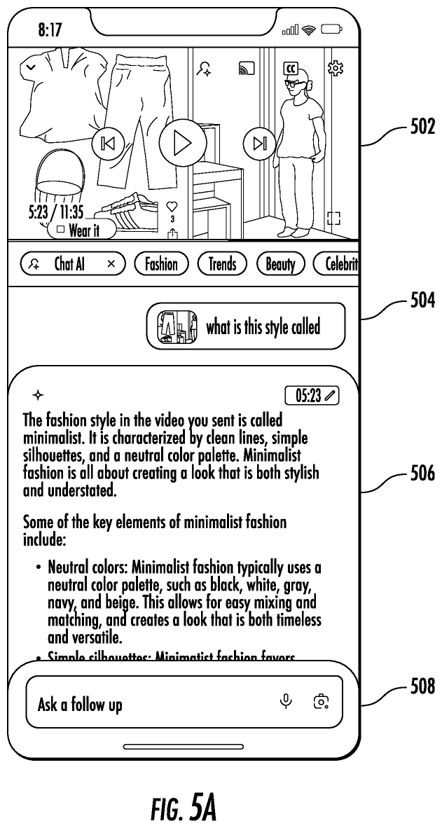

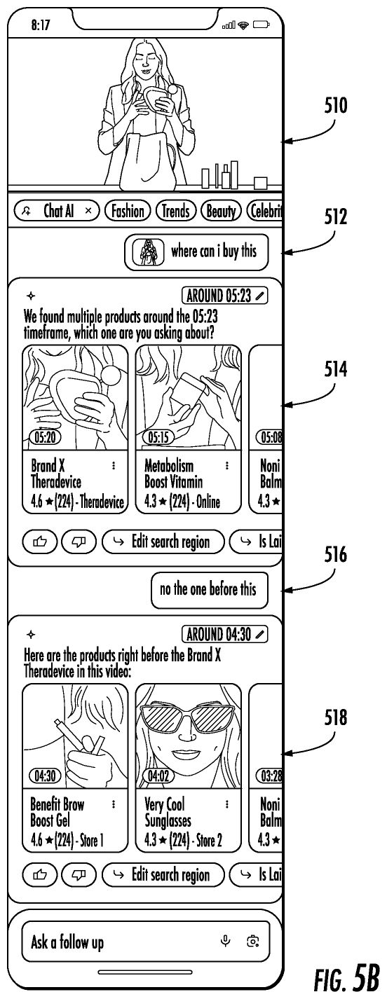

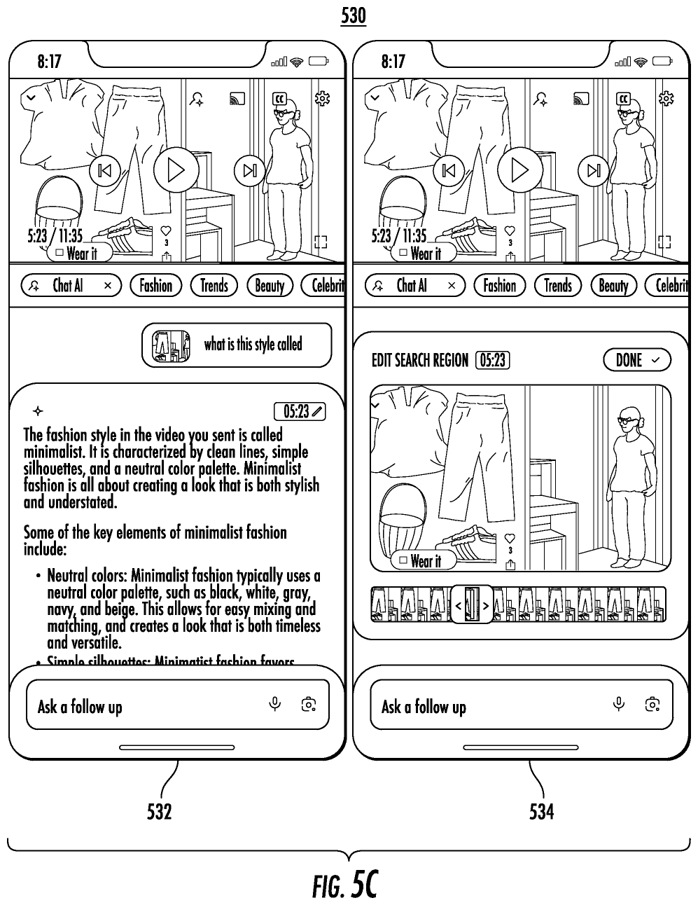

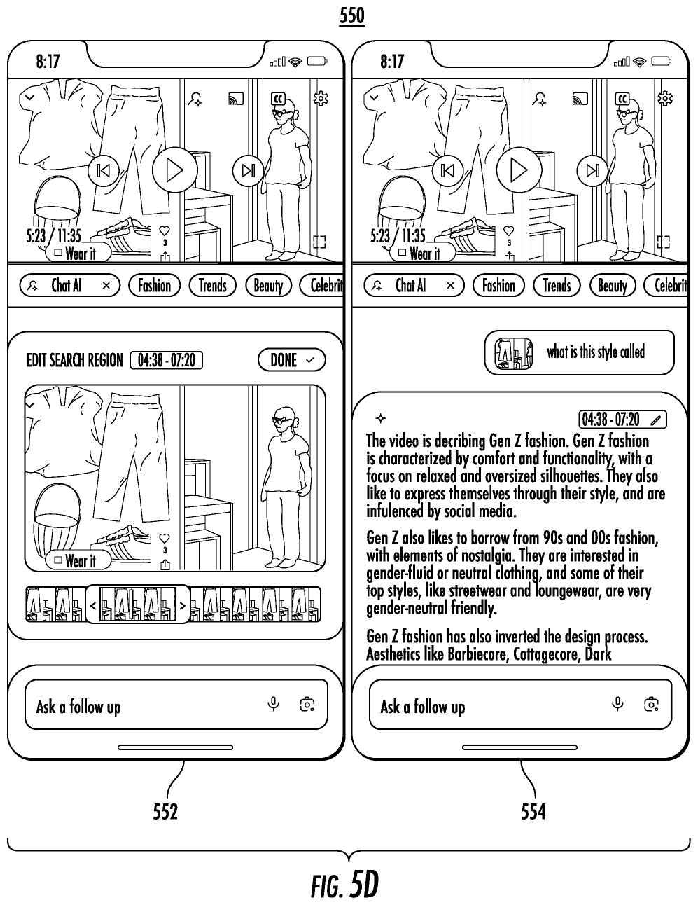

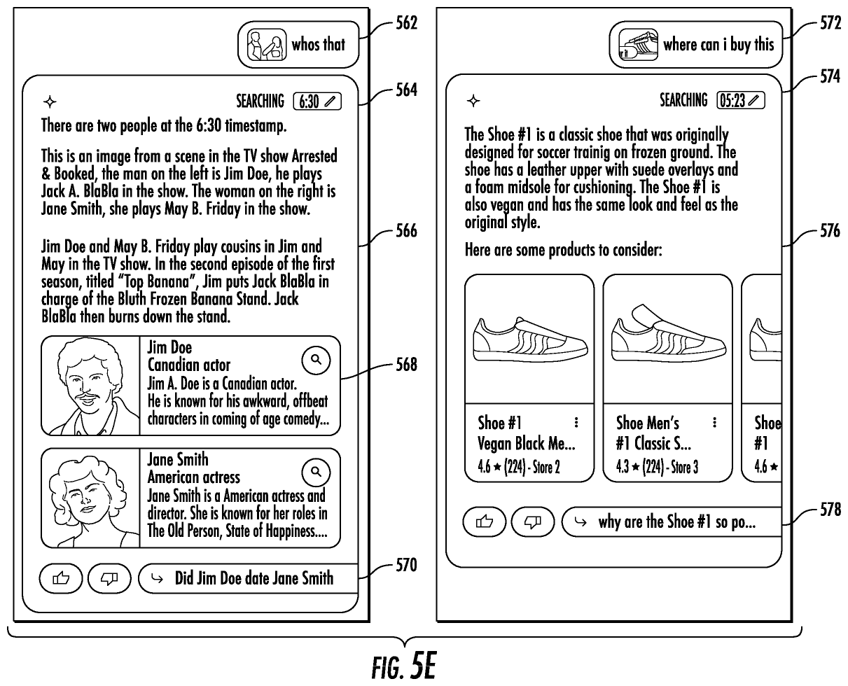

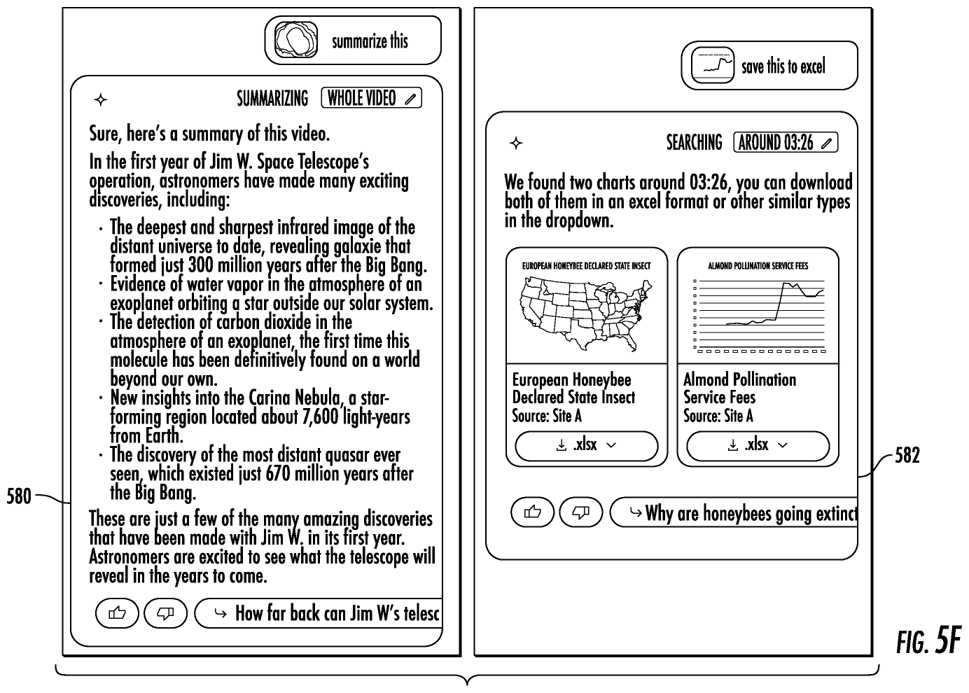

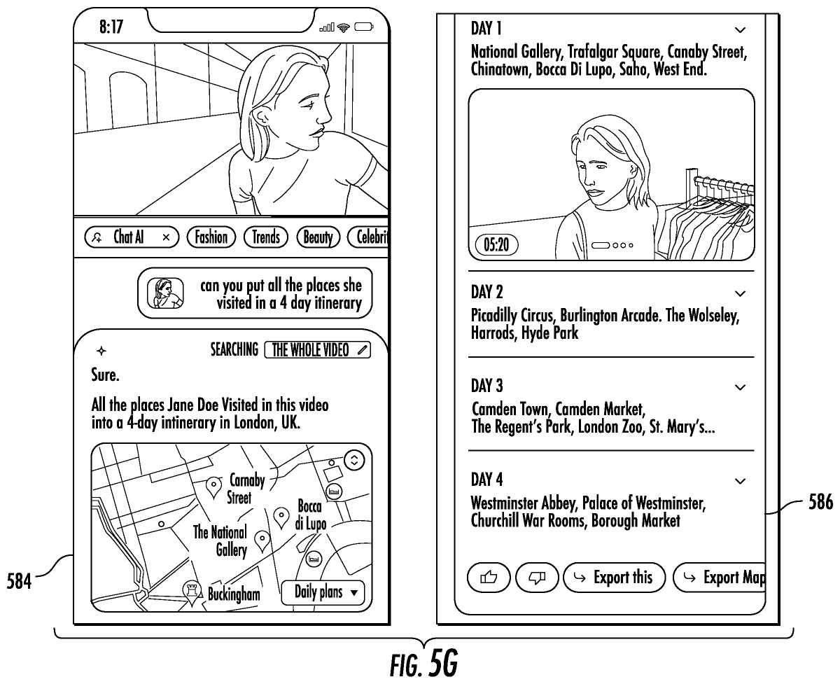

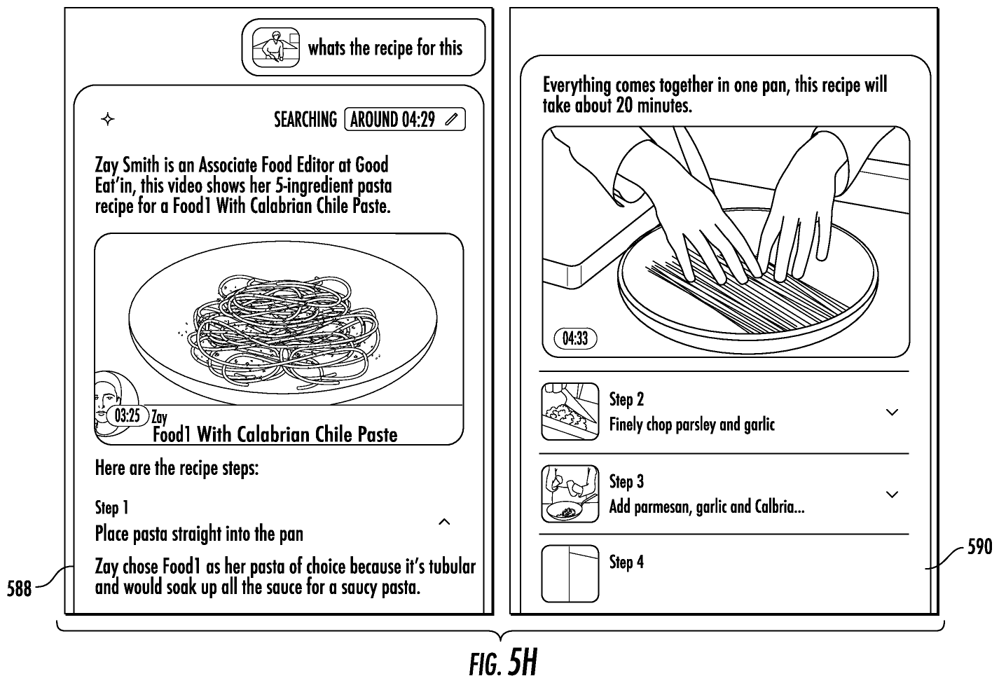

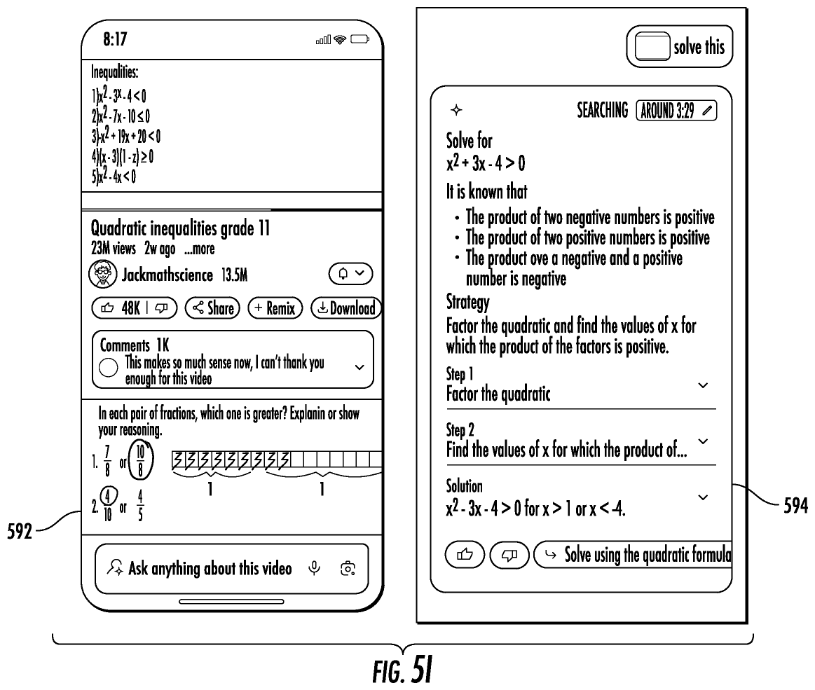

FIG. 5A depicts an illustration of an example generative response interface according to example embodiments of the present disclosure. In particular, FIG. 5A depicts an example generative response interface that continues to provide a display window 502 for the playback of the displayed video and a chat interface that depicts the input query 502, the query response 506, and a query input box 508 for inputting follow-up queries.

FIG. 5B depicts an illustration of an example follow-up response interface according to example embodiments of the present disclosure. In particular, FIG. 5B depicts another example response. However, FIG. 5 can further depict a follow-up query and a response to the follow-up query. For example, the displayed video 510 can be provided for display when a first query 512 is obtained. The first query 512 and video data can be processed to generate a first query response 514. The user may then respond with a second query 516 that may build off of the first query 512 and/or the first query response 514. The second query 516, the video data, the first query 512, and/or the first query response 516 can be processed to generate a second query response 518. The second query response 518 can be responsive to the second query 518 and may include data alluding to the previous responses and/or previous queries. The query responses can include text data, image data, search result data, product listings, audio data, multimodal data, and/or other data.

FIG. 5C depicts an illustration of an example customization interface 530 according to example embodiments of the present disclosure. In particular, FIG. 5C depicts an initial response 532 to an input query. A user may determine the initial response 532 does not address the intent of their query. The user may then select the time frame of the video that was processed to open a time customization window 534. The time customization window 534 can include a plurality of user interface element features for selecting a time frame of the video to search and/or regions of the frames that include features of interest.

FIG. 5D depicts an illustration of an example updated response interface according to example embodiments of the present disclosure. In particular, the user may change the time frame selected, as shown in 552. The updated time frame can be processed to determine an updated response, as shown in 554. The updated response can differ from the initial response 532 based on the adjusted video context.

FIG. 5E depicts an illustration of example result response types according to example embodiments of the present disclosure. In particular, FIG. 5E depicts two example response interfaces with mixed data responses.

The first example response can be responsive to an identity query 562 that requests information on a person in the video. The first example response can be provided with a time indicator 564 associated with the portion of the video processed, a text response 566, a knowledge panel widget response 568, and/or one or more follow-up query suggestions 570. The text response 566 may be a natural language response that may be generated with a generative language model that processed the input query 562, model output(s), and/or search result(s). The knowledge panel widget response 568 can be generated based on stored data, obtained data from web resources, and/or model-generated data. The knowledge panel widget response 568 can include an image, text, and/or one or more action elements that can be selected to perform an action (e.g., perform a search on the identified person). The one or more follow-up query suggestions 570 can be determined based on the intent of the input query 562, the query response, and/or the video data.

The second example response can be responsive to a product purchase query 572 that requests information on where to purchase a product displayed in the video. The second example response can be provided with a time indicator associated with the portion of the video processed, a text response 574, a product listing widget response 576, and/or one or more follow-up query suggestions 578. The text response 574 may be a natural language response that may be generated with a generative language model that processed the input query 572, model output(s), and/or search result(s). The product listing widget response 576 can be generated based on identified web resources that list the identified product for sale. The product listing widget response 576 can include an image, text, and/or one or more action elements that can be selected to perform an action (e.g., perform a web resource redirect and/or to purchase the product). The one or more follow-up query suggestions 578 can be determined based on the intent of the input query 572, the query response, a purchase history, a search history, a browsing history, and/or the video data.

FIG. 5F depicts an illustration of example generative response types according to example embodiments of the present disclosure. In particular, FIG. 5F depicts two example tasks that can be performed via the video query contextualization system.

For example, the video query contextualization system can perform video summarization to generate a summary response 580 in response to a query (and/or prompt) requesting a summary. The summary can be generated by processing the video data with one or more generative models. For example, the transcript may be encoded with a text encoder, and the plurality of frames may be encoded with an image encoder. The text encoding and the image encodings can then be processed with a text decoder to generate a text response. In some implementations, the text response, the text encoding, and/or the image encodings may be processed with a generative model configured and/or trained for summarization tasks.

Additionally and/or alternatively, the video query contextualization system can perform data extraction to generate graphs, tables, representations, and/or files that can be downloaded. The file response 582 may be generated via image cropping, optical character recognition, diagram recognition, and/or other data processing techniques. In some implementations, the file response 582 may be generated via one or more generative models, one or more application programming interface calls, and/or one or more external applications.

FIG. 5G depicts an illustration of an example itinerary response according to example embodiments of the present disclosure. In particular, FIG. 5G depicts an example itinerary response that may be generated in response to an input query (and/or prompt) that requests an itinerary be generated based on the locations in the video. The itinerary response can include a text response and a map 584 that lays out where each of the locations within the itinerary are. Additionally and/or alternatively, the itinerary response can include a day-by-day itinerary 586 on when and where to visit the locations within the video. The day-by-day itinerary 586 can include text directions along with images that may depict frames from the video that are associated with the location and/or may be images obtained from web resources via a search. The itinerary response may be generated with one or more generative models that may process the input query, the video data, search results, map data, and/or personal data.

FIG. 5H depicts an illustration of an example recipe response according to example embodiments of the present disclosure. In particular, FIG. 5H depicts an example recipe response that may be generated in response to an input query (and/or prompt) that requests a step-by-step recipe be generated based on the actions in the video. The recipe response can include a text response and a distilled video 588 that depicts a short video of the cooking steps. In particular, the distilled video may include a plurality of video clips segmented from the video and stitched together to generate a shorter video. Alternatively and/or additionally, the distilled video may be a video that is generated with a generative model based on a semantic understanding of the initial video. The distilled video may be generated by determining video segments associated with the recipe, segmenting the video segments, and stitching the video segments together. Additionally and/or alternatively, the recipe response can include step-by-step instructions 590 on the ingredients and techniques discussed within the video. The step-by-step instructions 590 can include text directions along with images that may depict frames from the video that are associated with the particular recipe step and/or may be images obtained from web resources via a search. The recipe response may be generated with one or more generative models that may process the input query, the video data, search results, and/or personal data.

FIG. 5I depicts an illustration of an example quantitative reasoning response according to example embodiments of the present disclosure. For example, the displayed video may include one or more depicted problems 592, which may include one or more math problems that may be solved via multi-step quantitative reasoning. The video query contextualization system may detect the problem within the video, and the router model may determine the extracted problem is to be processed with a generative model trained for quantitative reasoning, which may include a generative language model trained on multi-step quantitative reasoning. The extracted problem can be processed to generate a quantitative reasoning response 594 that includes the extracted problem, laws and/or theorems needed to solve the problem, a proof of how to solve the problem, the solution, and/or step-by-step instructions on how to solve the problem.

In generating the outputs (e.g., the query response and/or prompt response) for FIGS. 5G-5I, the video may be obtained and/or processed to generate a semantic understanding of the video. The semantic understanding may then be leveraged to generate a multimodal multi-part response. The multimodal multi-part response may include text generated with a generative model based on the semantic understanding. Additionally and/or alternatively, the multimodal multi-part response may include images and/or video clips generated by parsing (and/or segmenting) frames and/or video clips from the video based on the semantic understanding. In some implementations, the text data, image data, diagram data, and/or audio data from the multimodal multi-part response may be generated based on video metadata, which may include a transcript, chapters, entity labels, segment titles, thumbnails, and/or other metadata.

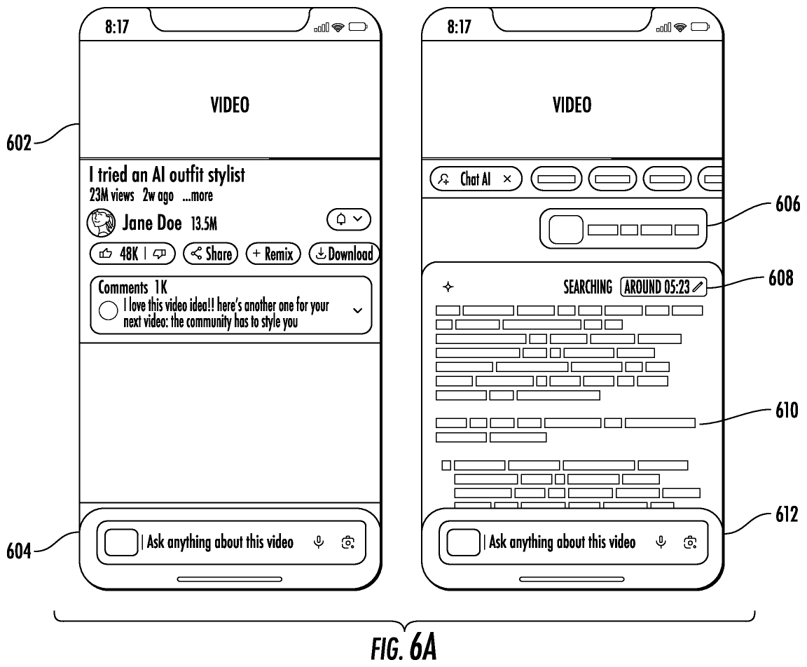

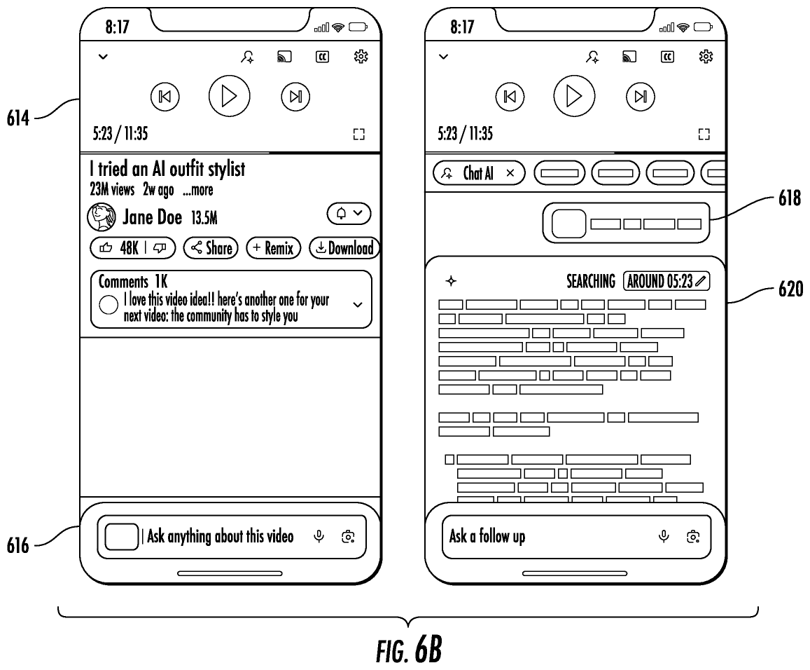

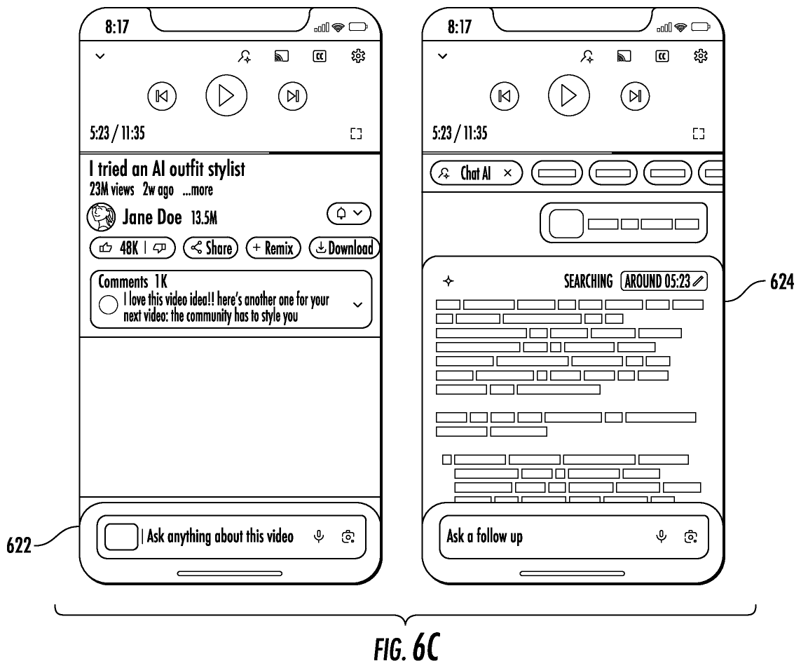

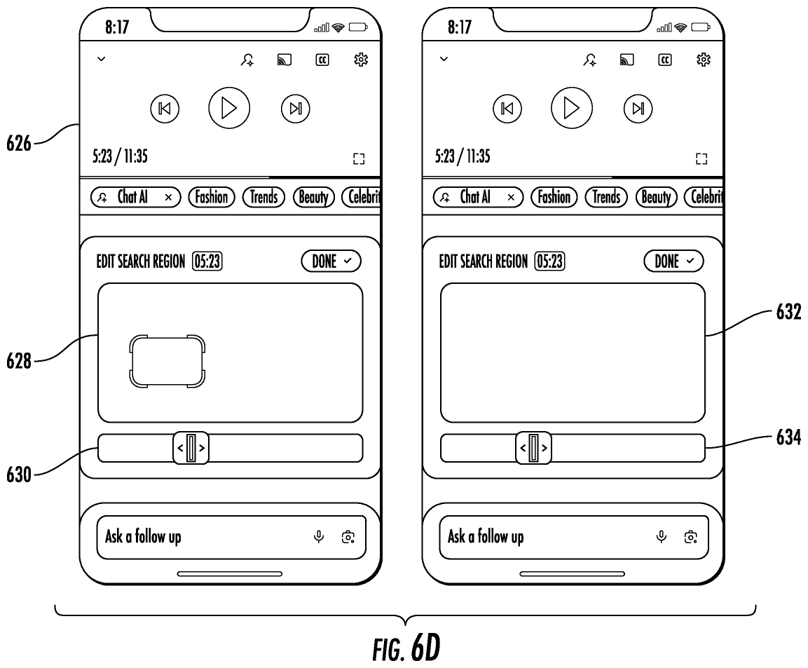

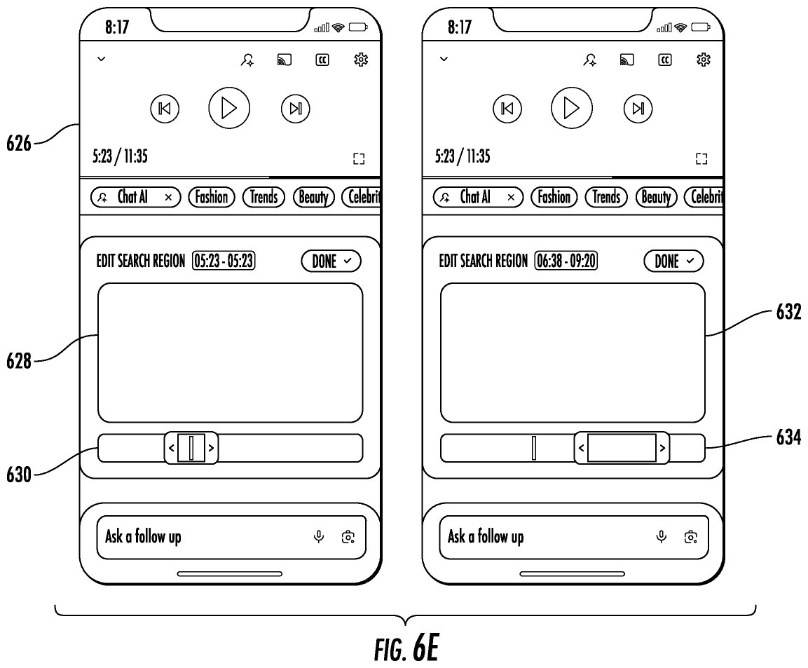

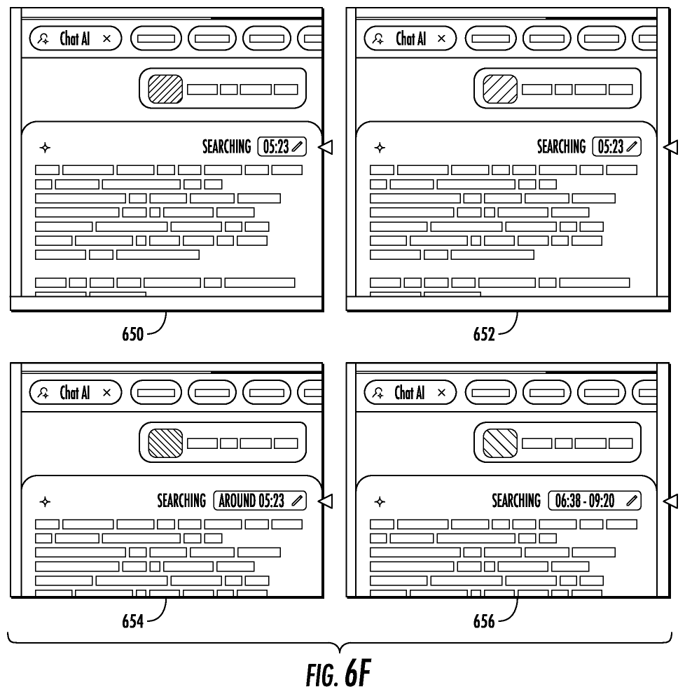

FIG. 6A depicts an illustration of an example video query processing interface according to example embodiments of the present disclosure. In particular, a video 602 may be provided for display in a browser, and/or a video player application. The video 602 may be displayed with a query input box 604 that can be configured to receive user inputs associated with an input query.

The video query processing interface can obtain an input query 606 via the query input box 604. The input query 606 can be processed with the video query contextualization system to generate a query response 610 that may be provided for display with a time indicator 608, the input query 606, the video 602, and a follow-up query input box 612 for receiving follow-up queries.

FIG. 6B depicts an illustration of an example frame processing interface according to example embodiments of the present disclosure. In particular, the video query contextualization system may determine a paused frame is to be processed when the video 614 is paused before receiving an input query 618 via the query input box 616. The time indicator 620 may reflect the time associated with the frame along with indicating only that frame was processed. In some implementations, the video query contextualization system may also process metadata, the title, and/or the description of the video with the particular frame to generate the query response.

FIG. 6C depicts an illustration of an example clip processing interface according to example embodiments of the present disclosure. In particular, the video query contextualization system may determine a plurality of frames are to be processed when the video is still playing during the obtainment of the input query via the query input box 622. The time indicator 620 may reflect the time associated with the sequence of frames along with indicating that a plurality of frames were processed and not just a single frame. In some implementations, the video query contextualization system may also process metadata, the title, and/or the description of the video along with the sequence of frames to generate the query response.

FIG. 6D depicts an illustration of an example manual selection interface according to example embodiments of the present disclosure. In particular, a video 626 may be provided for display, and a particular region of the frames may be of interest to the user. The selection interface may include a time selection bar 630 and 634 for selecting portions of the video of interest to a user by selecting thumbnail regions associated with the times of interest. Alternatively and/or additionally, the selection interface may include a cropping option 628 that may enable a user to select regions of the frames that are of interest. In some implementations, a user may select the entire frame 632. In the instance of a cropping selection, the video clip may be generated by both segmenting the portion of the video associated with the selected times and by cropping the frames based on the cropping selection associated with the region of interest.

FIG. 6E depicts an illustration of an example automated selection interface according to example embodiments of the present disclosure. In particular, the frames and/or video clips processed along with the input query may be automatically selected based on query intent understanding and/or video understanding. For example, the input query and video data associated with a displayed video may be processed to determine a frame and/or a video segment of the video are associated with the input query. The frame 636 and/or the video segment 640 may be provided for display in a viewing window along with respective frame selection bars 638 and 642. The user may then approve the selection and/or adjust the selection before processing the frames and/or video segments.

FIG. 6F depicts an illustration of example search selection interface elements according to example embodiments of the present disclosure. In particular, the time indicator for different contexts may differ. At 650, a time indicator associated with a region in a static frame specified by the user can be provided for display. At 652, a time indicator associated with a static frame specified by a pausing of the video before search can be provided for display. At 654, a time indicator associated with an approximated video clip (e.g., a video clip with buffer time based on a low probability determination and/or a deterministic approximation (e.g., +/−fifteen seconds from a paused frame and/or a frame depicted when query was input)) can be provided for display. At 656, a time indicator associated with an exact video clip (e.g., a manually selected clip and/or an automatically generated clip based on a high probability determination) can be provided for display.

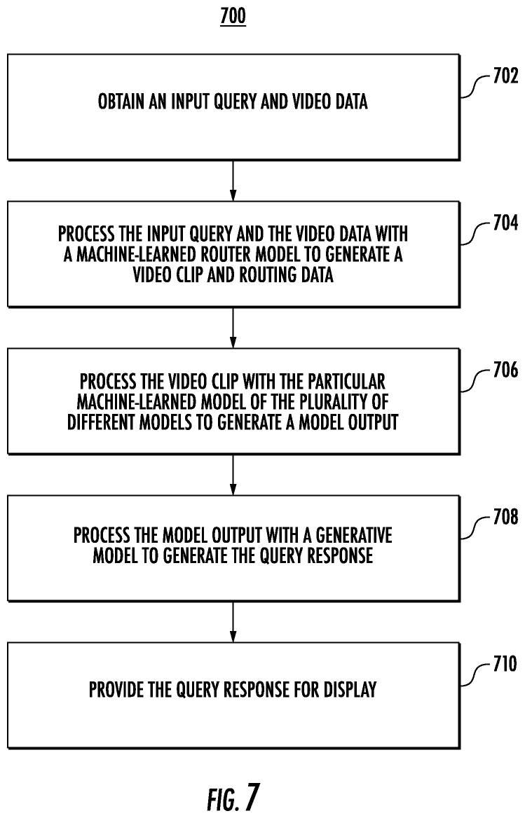

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an input query and video data. The input query can be associated with a displayed video. The video data can be associated with the displayed video. The displayed video can be posted by another user via a video sharing platform. The displayed video may include cooking content, skit content, gaming content, movie content, show content, do-it-yourself content, traveling content, and/or other content. The input query may be descriptive of a request for additional information on an object, location, and/or other content in the displayed video.

At 704, the computing system can process the input query and the video data with a machine-learned router model to generate a video clip and routing data. The video clip can be generated based on the input query. In some implementations, the video clip can include a plurality of frames from the displayed video. The routing data can include a determination of a particular machine-learned model of a plurality of different models to process the video clip with to determine a query response. The routing data can include one or more application programming interface calls associated with transmitting the video clip to the particular machine-learned model and obtaining model output. In some implementations, the video clip may include a sequence of frames segmented from the displayed video and/or metadata associated with the sequence of frames segmented from the displayed video. The video clip may include frame cropping to focus on a particular region of the frames that are of interest (e.g., cropping to focus on an object of interest). The video clip may be generated based on processing the video data with a segmentation model that may receive the video data based on instructions generated by the router model.

At 706, the computing system can process the video clip with the particular machine-learned model of the plurality of different models to generate a model output. The model output can be associated with features in the video clip. In some implementations, the particular machine-learned model can include a vision language model. The vision language model can be configured to process image data and generate text data descriptive of features of the image data. Alternatively and/or additionally, the particular machine-learned model may include a classification model, a detection model, an augmentation model, a segmentation model, a transcription model, a semantic understanding model, a sentiment analysis model, an encoder model, a decoder model, a translation model, and/or other models.

At 708, the computing system can process the model output with a generative model to generate the query response. The generative model can include a natural language processing model. In some implementations, the generative model may process the model output and the input query to generate a query response that is structured to be directly responsive (and/or conversationally responsive) to the input query. The generative model may be trained and/or configured for short-form content generation, long-form content generation, list generation, map generation, multimodal generation, step-by-step instruction generation, recipe generation, itinerary generation, graph generation, table generation, and/or other content generation types. The query response may be structured as a conversational response to provide a chat bot interface for receiving and responding to questions about the video.

At 710, the computing system can provide the query response for display. The query response can be provided for display with the displayed video. The query response may be provided as an overlay, in a chat interface provided for display adjacent to the video, and/or in another format. The query response may be provided with one or more follow-up query suggestions and/or one or more action options (e.g., video commenting, AR/VR experience, redirect to a search results page, and/or other options).

In some implementations, the computing system can process the video clip with a segmentation model to generate a plurality of segmentation masks associated with a plurality of frames of the video clip. The plurality of segmentation masks can be descriptive of a silhouette of a particular object in the plurality of frames of the video clip. The computing system can then generate an augmented video clip based on the video clip and the plurality of segmentation masks. The augmented video clip can include the video clip with one or more graphical indicators associated with the particular object. The computing system can provide the augmented video clip for display. The one or more graphical indicators can include highlighting the particular object within the augmented video clip. Alternatively and/or additionally, the one or more graphical indicators can include tinting portions of the plurality of frames of the video clip that are outside the silhouette of the particular object.

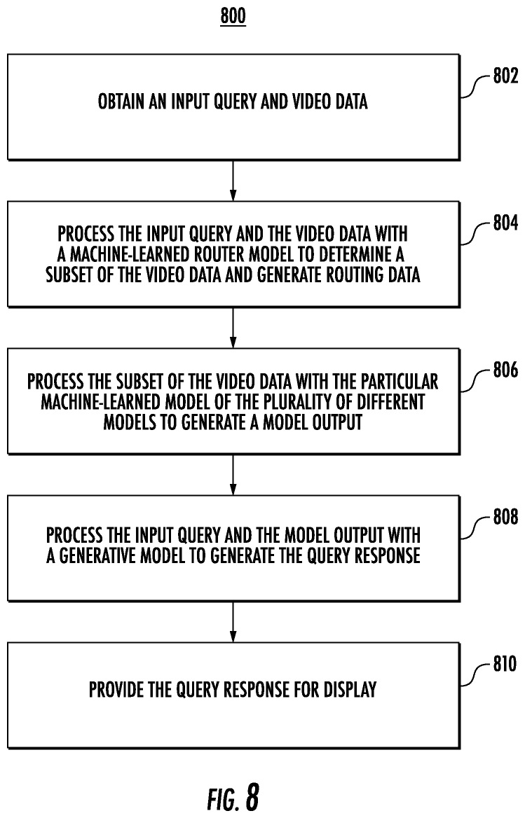

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain an input query and video data. The input query can be associated with a displayed video. The input query may include a text string descriptive of a question about the displayed content. The video data can be associated with the displayed video. In some implementations, the video data may be obtained and/or generated based on the input query. Alternatively and/or additionally, the video data may be obtained upon selection of the displayed video for playback.

At 804, the computing system can process the input query and the video data with a machine-learned router model to determine a subset of the video data and generate routing data. The subset of the video data can be determined based on the input query. The subset of the video data can include data associated with the displayed video. In some implementations, the routing data can include a determination of a particular machine-learned model of a plurality of different models to process the subset of the video data with to determine a query response. The subset of the video data can include a subset of a plurality of entity tags associated with detected features in the displayed video. The plurality of different models can include a vision language model, an embedding model, and a plurality of classification models. The subset of video data may be associated with isolating data that is determined by the router model to be potentially relevant to the input query. In some implementations, the subset of the video data may be processed with a saliency model to determine data features of potential interest that may then be processed with the particular machine-learned model.

At 806, the computing system can process the subset of the video data with the particular machine-learned model of the plurality of different models to generate a model output. The model output can be associated with features in the subset of the video data. The model output can include a generated caption, a classification label, a search result, a summary, and/or other output. The particular machine-learned model may include a generative model, a deterministic model, and/or a hybrid model.

At 808, the computing system can process the input query and the model output with a generative model to generate the query response. The query response can include a natural language response that is responsive to the input query and comprises details from the model output. The query response may include structured text data, image data, graph data, list data, tabular data, multimodal data, and/or other data.

At 810, the computing system can provide the query response for display. The query response can be provided for display with the displayed video. The query response may be initially provided in a condensed format that can then be expanded to a longer format based on a user selection (e.g., a short and direct response that may be selected to provide a detailed response). Alternatively and/or additionally, a first content type may be provided for display with an option to view the response in a second content type upon selection.

In some implementations, the computing system can obtain a progress bar selection and generate a video clip based on the progress bar selection. The model output may be generated by processing the video clip with the particular machine-learned model of the plurality of different models.

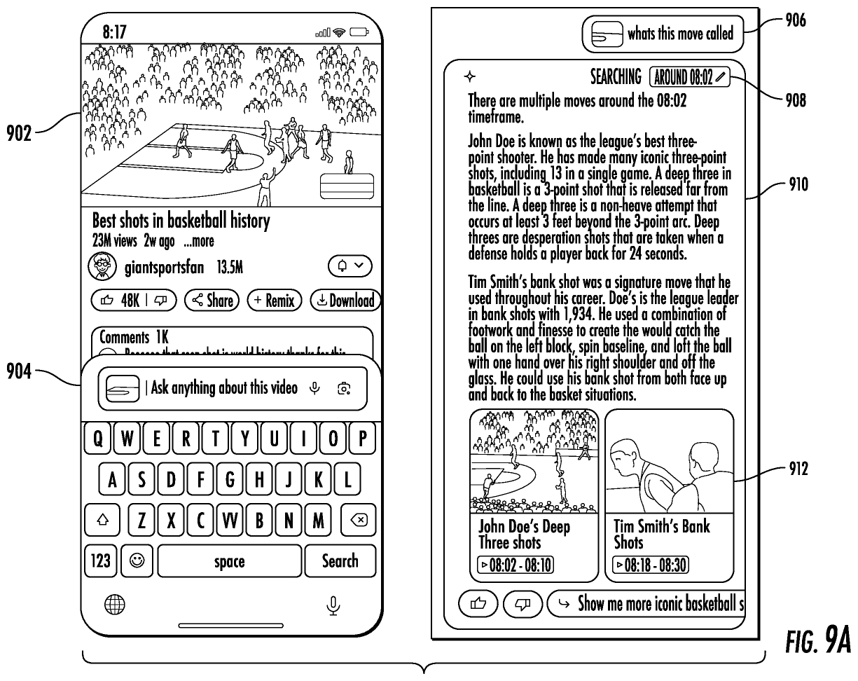

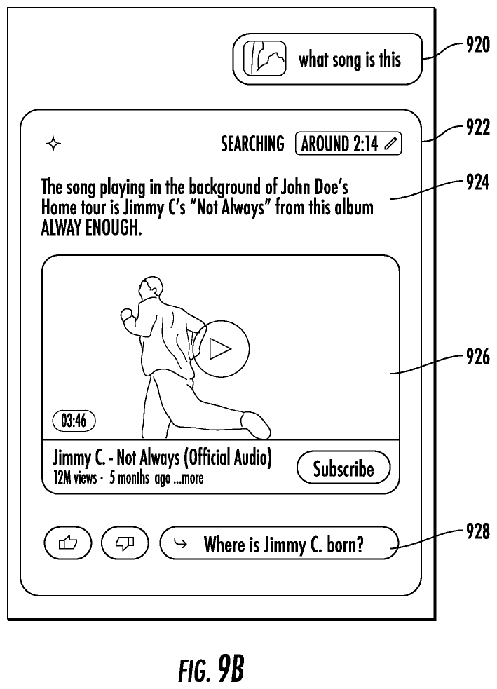

FIG. 9A depicts a block diagram of an example clip search interface according to example embodiments of the present disclosure. The clip search interface can continually provide the video 902 for display such that the video continues to play as the input query is received and processed. The input query may be obtained via a query input box 904 of the clip search interface. The video query contextualization system can process the input query and video data associated with the video 902 to generate a query response.

The clip search interface can then provide the query response for display with the video 902, the input query 906, a time indicator 908, rating options, and/or follow-up action suggestions (e.g., a follow-up query suggestion). The query response can include a text response 910 generated by processing the input query 906 and one or more model outputs with a generative language model. The query response may additionally include video clips 912 from the video 902 and/or from other videos (e.g., other videos determined to include the sequence of interest to the user (e.g., the basketball move)).

FIG. 9B depicts a block diagram of an example song search interface according to example embodiments of the present disclosure. In particular, users may request additional information associated with the audio of the video. A transcript of the audio and/or the audio may then be isolated and processed to perform the search. For example, the song search interface may obtain an input query 920 asking “what song is this”. The router model may process the input query 920 to determine the audio and/or the transcript are relevant for the query. The audio, the metadata associated with the audio, and/or the transcript may then be segmented from the video data and processed with one or more processing systems (e.g., an audio encoder and/or a search engine) to generate a query response. The query response may be provided with a time indicator 922 rating options, sharing options, and/or one or more follow-up query suggestions 928. The query response may include a text response 924 and/or a search result 926. The search result 926 may include an image, audio, video, text, action interface elements, and/or other data.

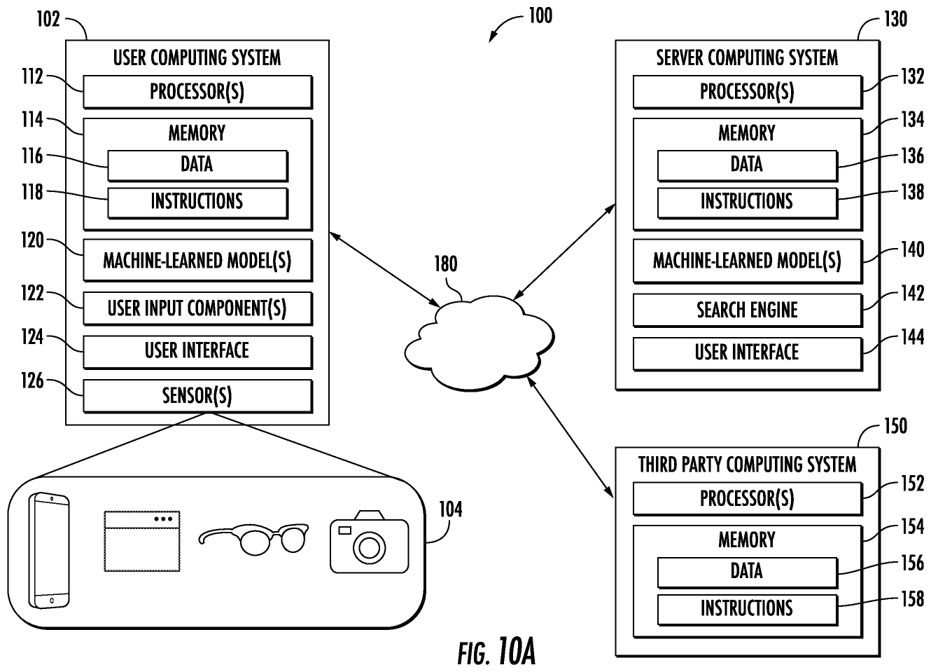

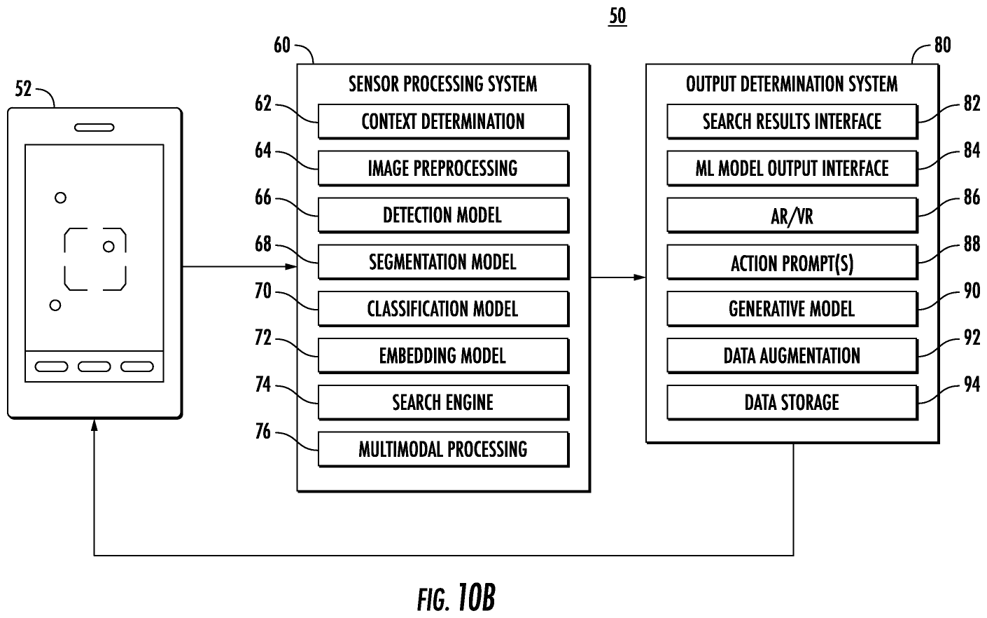

FIG. 10A depicts a block diagram of an example computing system 100 that performs video query contextualization according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 140 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 10B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 50 that performs video query contextualization according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g. for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for processing a query associated with a video, the system comprising:
one or more processors; and
one or more non-transitory computer-readable media that collectively store instructions that, when executed by the one or more processors, cause the computing system to perform operations, the operations comprising:
obtaining an input query and video data, wherein the input query is associated with a video, and wherein the video data is associated with the video;
processing the input query and the video data with a machine-learned router model to generate a video clip and routing data, wherein the video clip is generated based on the input query, wherein the video clip comprises a plurality of frames from the video, and wherein the routing data comprises a determination of a particular processing system of a plurality of different processing systems to process the video clip with to determine a query response, wherein the machine-learned router model determines a context of when the input query was input relative to what sequence of frames of the video was displayed when the input query was input, determines a particular portion of the video data associated with the input query and the context of when the input query was input to generate the video clip, and determines the particular processing system of the plurality of different processing systems to process the video clip;
processing the video clip with the particular processing system of the plurality of different processing systems to determine one or more search results, wherein the one or more search results are associated with features in the video clip; and
providing the one or more search results for display.

2. The system of claim 1, wherein the video is a displayed video that is currently provided for display, wherein the one or more search results are provided for display with the displayed video, wherein the video clip is generated based on the input query and a currently displayed frame of the displayed video, wherein the video clip comprises the currently displayed frame.

3. The system of claim 2, wherein the video clip and routing data are generated without navigating away from a video playback of the displayed video, and wherein the one or more search results are determined without navigating away from the video playback of the displayed video.

4. The system of claim 1, wherein the operations further comprise:
before obtaining the input query:
obtaining the video;
processing the video with a transcription model to generate a transcript for the video;
processing the video with one or more coarse classifiers to generate a plurality of entity tags associated with a plurality of objects detected in the video; and
generating the video data based on the video, the transcript, and the plurality of entity tags.

5. The system of claim 1, wherein the video data comprises data associated with the plurality of frames of the video, one or more entity tags associated with features in the video, and metadata associated with the video.

6. The system of claim 5, wherein the one or more entity tags were generated and stored before the input query is obtained.

7. The system of claim 5, wherein the one or more entity tags are generated by:
processing the plurality of frames with one or more classification models to determine one or more classification labels based on detected features in the plurality of frames; and
generating entity tags for one or more respective frames of the plurality of frames, wherein the one or more entity tags are descriptive of the one or more classification labels associated with the one or more respective frames.

8. The system of claim 1, wherein the machine-learned router model is trained to segment data from video data based on the query and determine processing instructions.

9. The system of claim 1, wherein the machine-learned router model comprises a generative language model trained to generate application programming interface calls.

10. The system of claim 1, wherein the particular processing system comprises one or more embedding models, one or more search engines, and one or more databases.

11. A computer-implemented method for processing a query associated with a video, the method comprising:
obtaining, by a computing system comprising one or more processors, an input query and video data, wherein the input query is associated with a video, and wherein the video data is associated with the video;
processing, by the computing system, the input query and the video data with a machine-learned router model to generate a video clip and routing data, wherein the video clip is generated based on the input query, wherein the video clip comprises a plurality of frames from the video, and wherein the routing data comprises a determination of a particular machine-learned model of a plurality of different models to process the video clip with to determine a query response, wherein the machine-learned router model:
determines a context of when the input query was input relative to what sequence of frames of the video was displayed when the input query was input,
determines a particular portion of the video data associated with the input query and the context of when the input query was input to generate the video clip, and
determines the particular processing system of the plurality of different processing systems to process the video clip;
processing, by the computing system, the video clip with the particular machine-learned model of the plurality of different models to generate a model output, wherein the model output are associated with features in the video clip;
processing, by the computing system, the model output with a generative model to generate the query response, wherein the generative model comprises a natural language processing model; and
providing, by the computing system, the query response for display, wherein the query response is provided for display with the video.

12. The method of claim 11, wherein the particular machine-learned model comprises a vision language model, wherein the vision language model is configured to process image data and generate text data descriptive of features of the image data.

13. The method of claim 11, further comprising:
processing, by the computing system, the video clip with a segmentation model to generate a plurality of segmentation masks associated with a plurality of frames of the video clip, wherein the plurality of segmentation masks are descriptive of a silhouette of a particular object in the plurality of frames of the video clip;
generating, by the computing system, an augmented video clip based on the video clip and the plurality of segmentation masks, wherein the augmented video clip comprises the video clip with one or more graphical indicators associated with the particular object; and
providing, by the computing system, the augmented video clip for display.

14. The method of claim 13, wherein the one or more graphical indicators comprises highlighting the particular object within the augmented video clip.

15. The method of claim 13, wherein the one or more graphical indicators comprises tinting portions of the plurality of frames of the video clip that are outside the silhouette of the particular object.

16. The method of claim 11, wherein the routing data comprises one or more application programming interface calls associated with transmitting the video clip to the particular machine-learned model and obtaining model output.

17. One or more non-transitory computer-readable media that collectively store instructions that, when executed by one or more computing devices, cause the one or more computing devices to perform operations, the operations comprising:
obtaining an input query and video data, wherein the input query is associated with a displayed video, and wherein the video data is associated with the displayed video, wherein the input query is obtained and displayed via a chat interface that is provided for display simultaneously with a viewing window that provides the displayed video for display;
processing the input query and the video data with a machine-learned router model to determine a subset of the video data and generate routing data, wherein the subset of the video data is determined based on the input query, wherein the subset of the video data comprises data associated with the displayed video, and wherein the routing data comprises a determination of a particular machine-learned model of a plurality of different models to process the subset of the video data with to determine a query response, wherein the machine-learned router model determines the subset of video data based at least in part on a context of when the input query is input relative to what sequence of frames of the video is displayed when the input query is input;
processing the subset of the video data with the particular machine-learned model of the plurality of different models to generate a model output, wherein the model output are associated with features in the subset of the video data;
processing the input query and the model output with a generative model to generate the query response, wherein the query response comprises a natural language response that is responsive to the input query and comprises details from the model output; and
providing the query response for display in the chat interface, wherein the query response is provided for display with the displayed video.

18. The one or more non-transitory computer-readable media of claim 17, wherein the subset of the video data comprises a subset of a plurality of entity tags associated with detected features in the displayed video.

19. The one or more non-transitory computer-readable media of claim 17, wherein the plurality of different models comprise a vision language model, an embedding model, and a plurality of classification models.

20. The one or more non-transitory computer-readable media of claim 17, wherein the operations further comprise:
obtaining a progress bar selection;
generating a video clip based on the progress bar selection; and
wherein the model output is generated by processing the video clip with the particular machine-learned model of the plurality of different models.
